(19) United States
(12) Patent Application Publication
(10) Pub. No.: US 2012/0107786 A1
(43) Pub. Date: May 3, 2012

(54) METHOD OF CREATING A FOUNDATIONAL INSTRUCTIONAL DESIGN MODEL FOR SHAREABLE CONTENT OBJECTS

(75) Inventors: Doug Brian Wallace, Toronto (CA); Isobel Sarah Jane Wallace, Toronto (CA); Steve Joseph Horvath, East York (CA); Kimberly Lianne Levo, Toronto (CA); Campbell James Macmillan, Oakville (CA); Smarandita Andreea Putinelu, Aurora (CA); Radu Pogaceanu, Toronto (CA); Joel Benjamin Aufgang, Thornhill (CA); Dale Robert Street, Toronto (CA)

(73) Assignee: Agile.net Inc., Toronto (CA)

(21) Appl. No.: 12/915,988

(22) Filed: Oct. 29, 2010

(51) Int. Cl. G09B 3/00

(52) U.S. Cl. 434/322

(57) ABSTRACT

A method is provided for creating a foundational instructional design model for shareable content object (SCO) by pre-defining a semantically structured reusable learning type (RLT), and joining individual or repeated RLT's with sequence or choice indicators to form an instructional design model. The instructional design model is itself a semantically structured document that can be used and reused to create SCOs.

### FIELD OF THE INVENTION

The invention relates to methods of generating learning materials, and in particular, relates to methods of generating shareable content objects via instructional designs.

### BACKGROUND OF THE INVENTION

The migration from traditional methods of authoring educational content to computer-based learning (or “e-learning”) has not been a smooth road. In order to generate e-learning materials, it has become the norm to simply take paper materials (or materials in a presentation deck) and simply code these into HTML.

The main problems of this approach are of educational rigor and efficiency. Either you do a straight conversion of print materials which are poor tools for educating or you have to get a trained instructional designer to review each piece of paper as it is moved into HTML.

Further problems arise when one attempts to reuse such e-courses and change the content. The HTML is a “dumb” format in that it does not care about the nature of content, only how they look. It is easy to inadvertently remove tags and mess up the overall look when trying to change the content.

If one attempts to concatenate several HTML “lessons” into one course, further problems arise. The lessons authored by different authors or designers will typically lack any uniform style conventions and they may also be pedagogically diverse. The need to basically re-write all the HTML to create this superficial uniformity after the fact is expensive and time-consuming.

The work of the ADL to bring consistency is very helpful, but their SCORM standard only deals with the packaging of courseware, not the content contained within. More recently, some of the downsides of HTML-authored courseware have been alleviated by switching to the use of XML to allow courses to be re-used with the content tagged meaningfully. A number of organizations have used XML to describe content to allow for reuse. However, XML editing software packages are typically very complex and intimidating for authors of e-learning materials and pedagogical designs. Selecting XML has had long term payoff but a huge upfront investment must be made before you can see a single page on a screen for a learner.

There is a need for a wholly new approach to learning materials development that begins with content-neutral and presentation-neutral building blocks but without the crippling overhead of the XML/SGML process.

### SUMMARY OF THE INVENTION

The invention relates to a new way of creating SCOs (shareable content objects). First, semantically structured RLTs (reuseable learning types) are defined that each contain the semantic structure of content that is to be created, skins for laying out how this RLT should be presented and instructions to the editor for how the author should use this RLT in the SCO editor. Next, we create an instructional design that is itself a semantically structured document made up entirely of RLTs. The instructional design can have “Themes” that are the total of all the Skins in its RLTs plus a configuration of display options allowed by the RLT's Skins. Finally, we have created an editor that guides an author though creating a document (SCO) based on the instructional design.

A method is provided for creating a foundational instructional design model for a shareable content object (SCO). The user defines a reusable learning type (RLT) in a semantic structure close in nature to a simplified XSD (Extensible Schema Document) that encapsulates the RLT, and joins the RLTs individually or in repeated fashion with sequence or choice indicators to form an instructional design model. This instructional design is itself a simplified XSD and can be used to create SCOs using a SCO Editor. (Note that XSD is used herein as an example of a semantically structured document, but the invention is not intended to be limited to or constrained by XSD.)

To define each RLT, a root element is first placed, and then:
1. a sequence or choice indicator is placed and defined;
2. at least one element is placed and defined for each sequence or choice indicator, the sequence and choice indicators defining the precise order in which the elements are to be presented, and if there is to be branching; and
3. steps (1) and (2) are repeated until an RLT is defined that logically forms an atomic segment of an instructional design model.

Elements are of one of the following types: container, text, number or media. Elements may have a single attribute. An attribute may be text, number or Boolean.

Elements (and choices) have occurrences. These set the number of instances of the element or number of choices that must be selected. The elements of the RLT can be nested.

An RLT contains instructions for how it is presented in the editor. This includes:
a. textual element i.e. underline, italicize, bold etc.
b. media element—what kind of media, i.e image, video, audio etc.

The RLT can also define its own editor that will be loaded into the SCO editor that is targeted for editing just this RLT.

Each RLT has any number of “skins” which define the presentation to the learner of content created using this skin. Skins are targeted to platforms and audiences to allow for maximum reusability. Part of the skin is defining parts of itself that are editable. These editable parts form a theme.

In the instructional design editor, the instructional design is created by assembling any number of RLTs into a model that describes your pedagogy.

A completed instructional design is loaded into the Sharable Content Object Editor and any number of SCOs that conform to that instructional design can be produced. The SCO editor is governed by the rules of the instructional design and is presented using the layout and editing rules defined in each of its RLTs.

### BRIEF DESCRIPTION OF THE FIGURES

FIG. 1 is a conceptual diagram of the relationship between elements/choices/sequences (particles), reusable learning types (atoms), and instructional design models (molecules).

FIG. 2 is a sample screen view of editing a reuseable learning type (RLT) “Multiple Choice Question”.

FIG. 3 is a sample screen view of editing an instructional design model for a shareable content object (SCO) using the RLT “Multiple Choice Question” among other RLT's.

FIG. 4 is a sample screen view of a skin editor.

FIG. 5 is a sample screen view of a theme editor.

FIG. 6 is a conceptual diagram of the separation of content (e.g. question about the capital of France) from presentation (e.g. font, colour and button choices) and delivery vehicle (e.g. web delivery).

FIG. 7 shows the sample code for the content (e.g. XML), presentation (e.g. Javascript, XSL and CSS) and delivery vehicle (e.g. HTML) aspects shown in FIG. 6.

### DETAILED DESCRIPTION

The present invention relates to methods of generating shareable content objects. Shareable content objects (SCOs) can be thought of as chapters of a course.

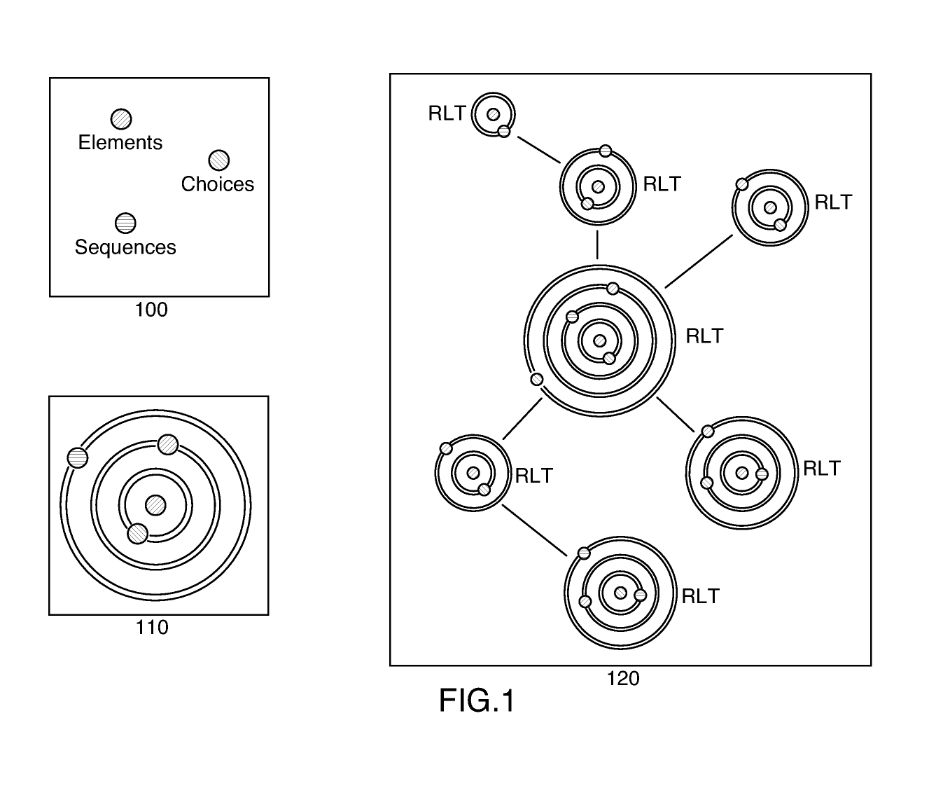

To understand the nature of an RLT within the larger world of instructional designs and SCOs, it is helpful to consider an analogy to chemistry. FIG. 1 illustrates this analogy in simple terms. On the left side, “particles” (in chemistry terms—like protons, electrons and neutrons) are shown, which in terms of the invention become elements, choices and sequences 100. In the middle, the “atoms” are the reusable learning types 110 made up of these particles. Examples of RLT's are multiple choice question, page, paragraph, ordered list, and more complex, like quiz or scenario. The “molecules” are shown on the right side. In the present terms, these are instructional designs 120 made up of individual RLTs. RLTs are grouped together to create an Instructional Design. SCOs are the documents that are then generated by authors. All the structure and rules lives in the instructional design. The SCO is the resulting document.

RLTs are assembled client side through the use of a web browser. Each element within a RLT is displayed in the Browser DOM using JavaScript, HTML and CSS. RLT elements are stored as JavaScript Objects client side using JSON (JavaScript Object Notation). This approach allows large amounts of data to be handled client side with little effect on client side performance. RLT objects when saved are transferred over HTTP as JSON Objects, the objects then are stored server side as JSON and XML. The JavaScript Objects can be serialized and de-serialized from JSON to XML and back to JSON. This mitigates the overhead of transferring extra data associated with XML in two ways:
smaller file size for transfer; and
no need for an XML parser on the client side.

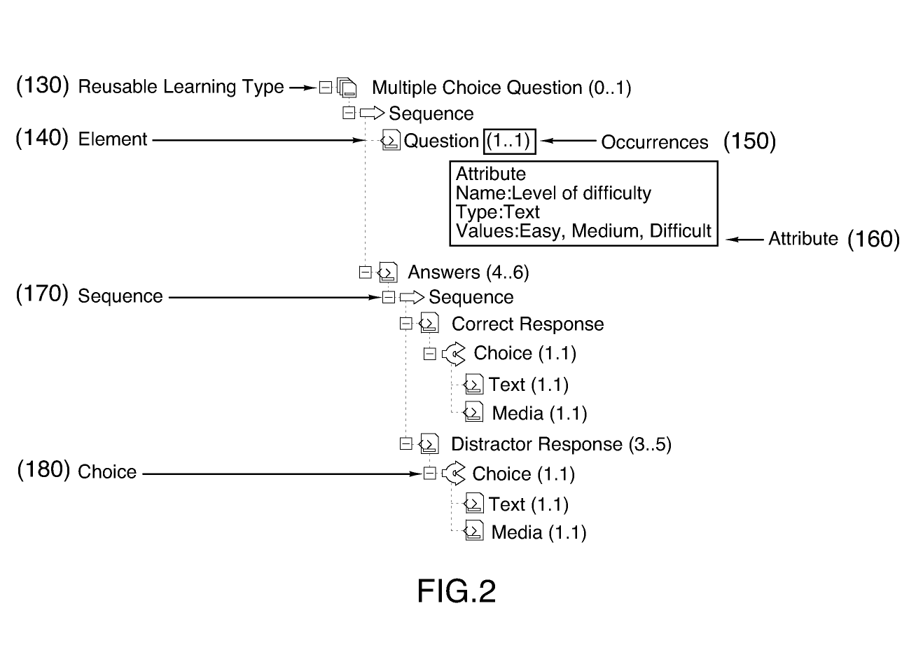

Turning to FIG. 2, we can demonstrate how a simple RLT is created in an editor. A root element for the RLT 130 is created called “Multiple Choice Question”. A sequence is placed below the root to indicate that this should be the first element. The first element 140 is called “Question” and it has only one occurrence 150. “Question” has an attribute 160 that defines the type as text and specifies that the question can have a level of difficulty value easy, medium or difficult. The next element is “Answers”, and this is defined as having 4-6 occurrences. A sequence 170 tells us that the next element is required (in this case, a “Correct Response” having one occurrence). A choice 180 indicator is placed to show that the correct response can be given in either text or media. “Distractor response” follows (3-5 occurrences). Again, these are specified as being either text or media. One or the other must be chosen by the author.

Looking at these concepts more abstractly, RLTs are fully contained structures. They can be as small as a single element or more complicated (like the multiple choice question example in FIG. 2). Each element has a type that tells what it can contain. For example, these can be containers, text, number or media types. Sequences give a closed-ended direction for the element, while choice indicates a branch. Choice allows parts of the document structure to be up to the author. The occurrences specify the minimum and maximum number of children in the list of choices. The actual number of each selected child is governed by the thing chosen itself.

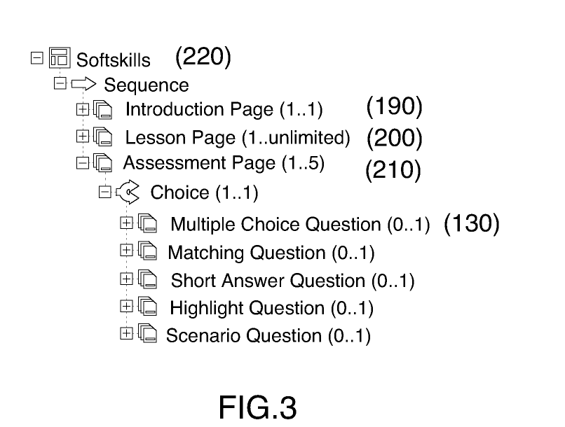

The creation of an instructional design is shown in FIG. 3. The instructional design can use one or more RLTs. The pre-defined RLTs can simply be plugged in, individually or repeated, in the design. Further, the design can use sequence and choice elements to guide the content author's process and options. As shown in FIG. 3, an instructional design 220 called “Softskills” has an introduction 190, one or more lesson pages 200, and then an assessment page 210. The assessment page uses a choice indicator to show that any one of the question types shown (including the pre-defined RLT “Multiple Choice Question” 130) can be used for the assessment. In the instructional design, all RLTs must be inside page RLTs. Pages are special RLTs that are single elements of the type Page.

In the instructional design, RLTs can be joined together by pages, container elements, sequences and choices to create a variety of instructional designs to fit any pedagogy.

The instructional design defines the entire SCO. The resulting document can contain many pages of content. This is a far cleaner process than authoring each page as a separate HTML document, and uniformity of the course shape and pedagogy is maintained no matter how big the authored document grows.

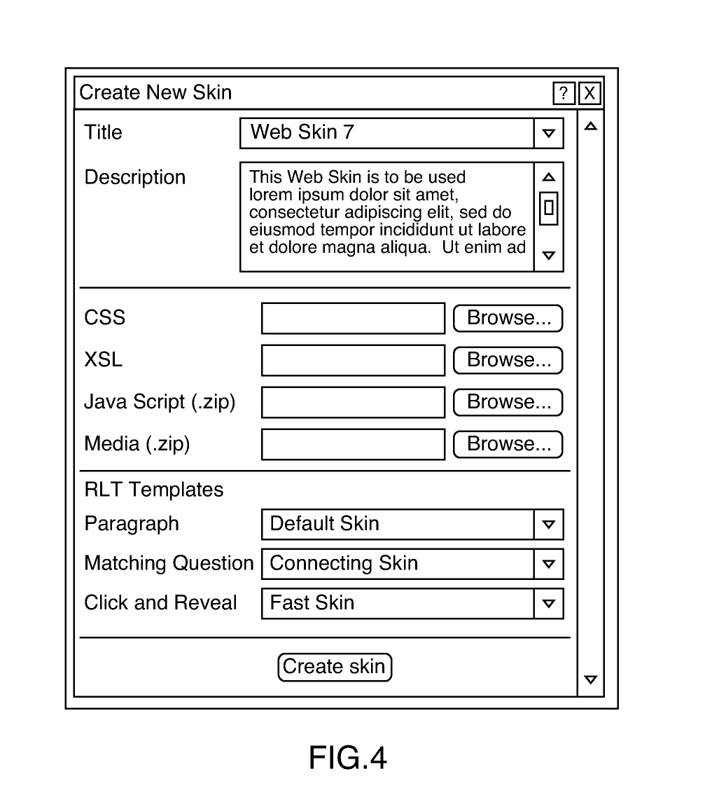

So far, all of the development processes are completely neutral as to content and appearance aspects. However, just as rules about the shape and pedagogy are imposed in the creation of RLT's and SCO's, the appearance and delivery can also be governed. The skins editor at FIG. 4 allows for the display options to be prescribed. The skins define how content created using the skin should be displayed. This can be over web, print, mobile. The skin holds all the rules and is created using open standards. Using a combination of XSL, CSS, Javascript and Media, the skin allows the creation of a blueprint for formatting endless courses without additional production work. The skins are reuseable across multiple SCO's and allow, for example, an entire university, to have one “look” for all of its course materials.

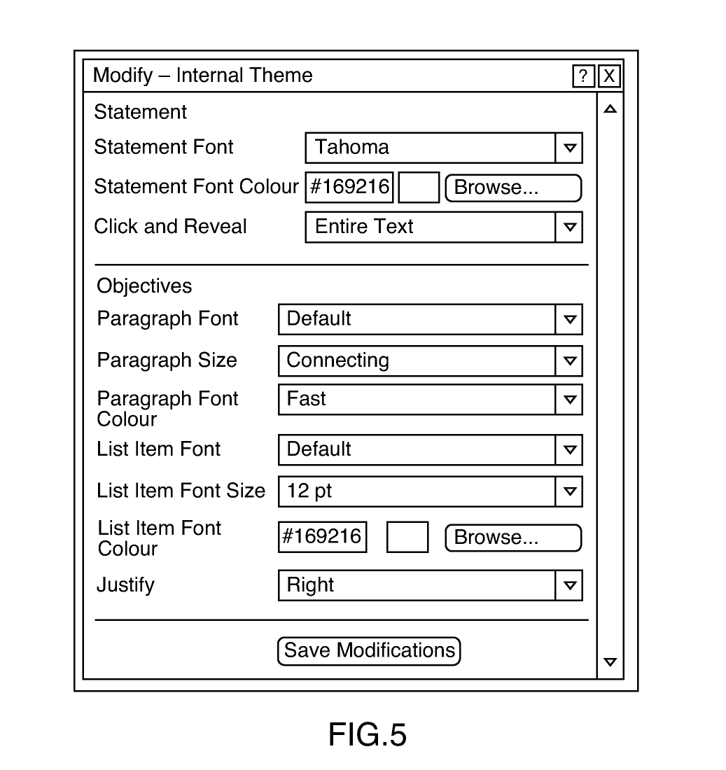

FIG. 5 illustrates the themes editor. When a designer creates a skin, they can annotate their files to indicate what is changeable in them and how the skin can be changed. For example, fonts and justification options can be specified. When a theme is created for an instructional design, all the change annotations contained in all the skin files used are assembled into a wizard. The resulting look and feel is a theme. Any number of themes can be created with little or no technical skills.

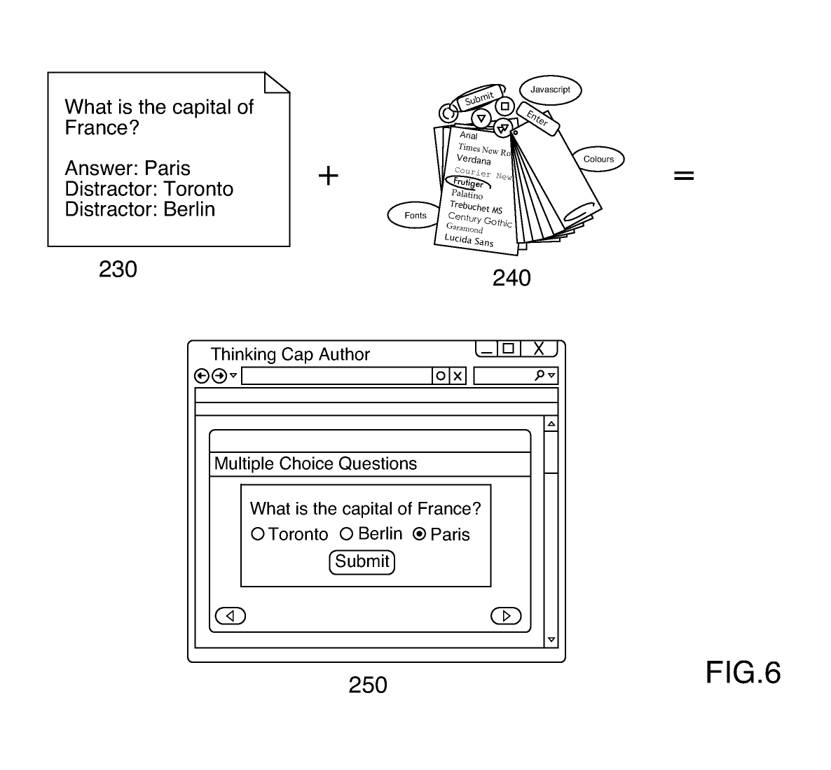

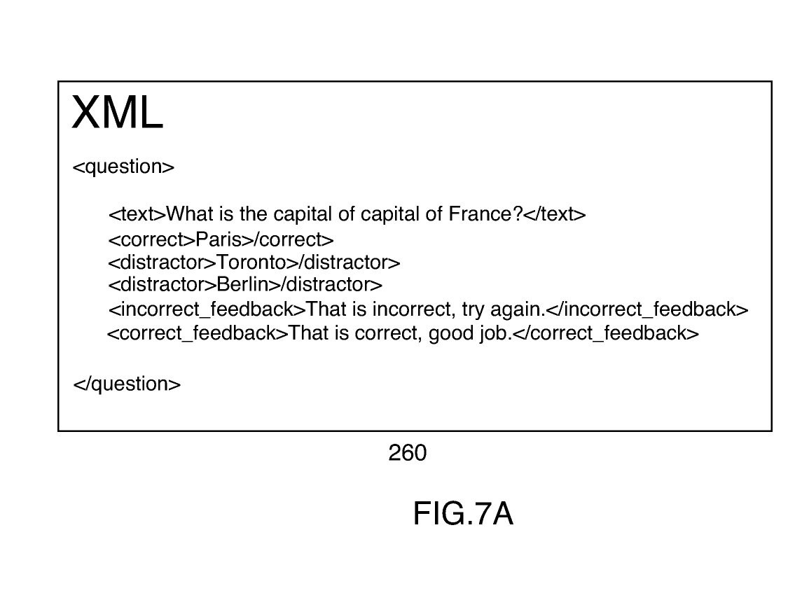

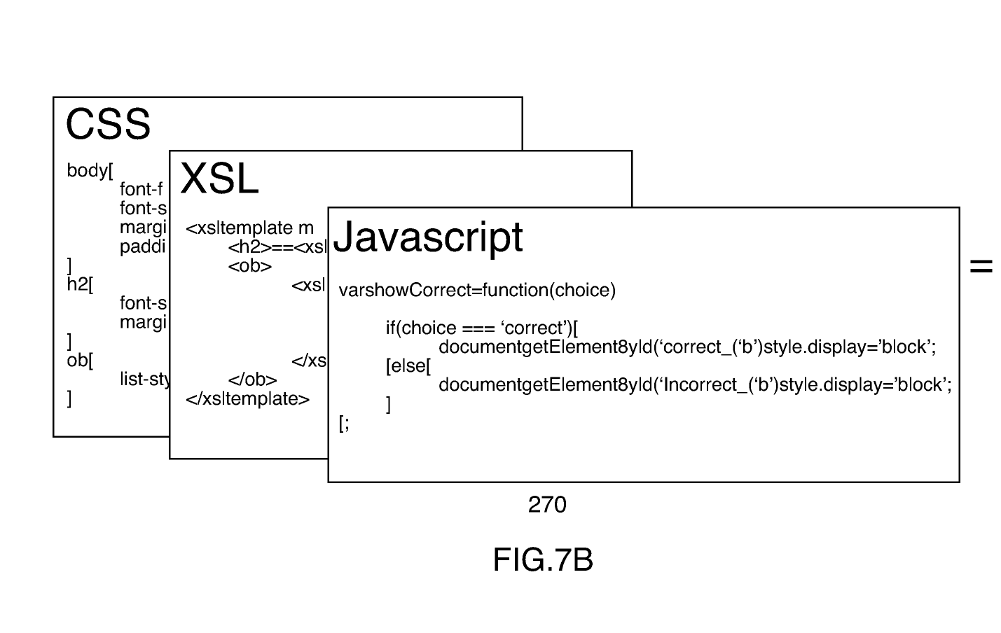

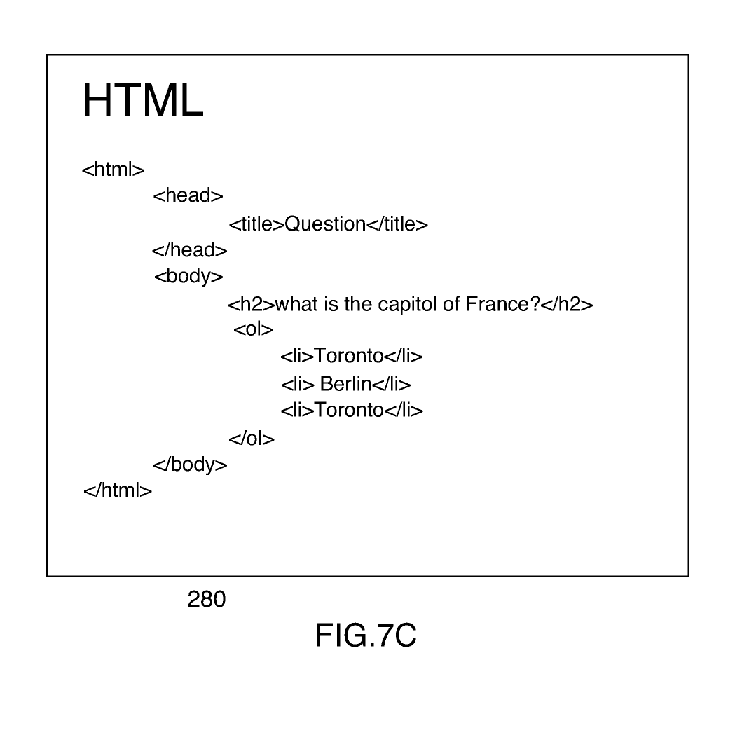

FIGS. 6 and 7 illustrate how content, presentation and delivery can be built separately but come together in one final product. In this case, the question 230 defined in the pre-existing XML of the SCO for the <question> is “What is the capital of France?” The question (as per the requirements for the definition of <question>) has distractors (Toronto and Berlin) and a correct answer (Paris). As shown in the XML code on FIG. 7, the question also specifies feedback in the event of a correct answer, and an incorrect answer.

The presentation layer 240 is separate from the content. Presentation choices selected in the Skin or Theme editors automatically generate relevant code in CSS, XSL, and Javascript for the presentation choices selected. The code, as can be seen from the snippets 260, 270, 280 on FIG. 7, is irrespective of the content itself. Web delivery 250 is shown in the example in FIG. 6. The HTML for this is also automatically generated based on options selected for how the delivery should work. This integrates the content authored in XML with the selected delivery. However, the content can still be reused across another delivery vehicle.

The foregoing description illustrates only certain preferred embodiments of the invention. The invention is not limited to the foregoing examples. That is, a person skilled in the art will appreciate and understand that modifications and variations or will be possible to utilize and carry out the teachings of the invention described herein. Accordingly all suitable modifications, variations and equivalence may be resorted to and such modifications, variations and equivalence are intended to fall within the scope of the invention as described and within the scope of the claims.

What is claimed is:

1. A method of creating a foundational instructional design model for creating shareable content objects (SCO) comprising:
a. pre-defining a semantically structured reusable learning type (RLT) by placing a root element and then:
i. placing and defining a sequence or choice indicator;
ii. placing and defining at least one element for each sequence or choice indicator, the sequence and choice indicators defining the precise order in which the elements are to be presented, and if there is to be branching; and
iii. repeating (i) and (ii) until an RLT is defined that logically forms an atomic segment of the instructional design model; and
b. joining individual or repeated RLT's with further sequence or choice indicators to form an instructional design model;
wherein the instructional design model is itself a semantically structured document that can be used and reused to create SCOs.

2. The method of claim 1, wherein the element comprises one of the following types: container, text, number or media.

3. The method of claim 1, wherein step (ii) of step (a) further comprises defining an attribute of the element.

4. The method of claim 3, wherein the attribute comprises one of the following types: text, number, or Boolean.

5. The method of claim 1, wherein step (ii) of step (a) further comprises defining occurrences of the element.

6. The method of claim 1, wherein the elements of the RLT can be nested.

7. The method of claim 1, further comprising defining a skin which sets out how any authored content put into the SCO must be displayed.

8. The method of claim 8, wherein the skin is targeted at a final delivery vehicle.

9. The method of claim 9, wherein the final delivery vehicle comprises web, print or mobile format.

10. The method of claim 8, further comprising defining a theme which sets out how the skin is changeable and what can be changed.

11. The method of claim 1, wherein the instructional design model can be loaded into a shareable content object (SCO) editor to write any number of SCOs that conform to the instructional design model.
